(19) United States
(12) Patent Application Publication
(10) Pub. No.: US 2024/0339865 A1
(43) Pub. Date: Oct. 10, 2024

(54) ENERGY HARVESTING DEVICES AND METHODS

(71) Applicant: BARACODA DAILY HEALTHTECH, Neuilly-sur-Seine (FR)

(72) Inventors: Thomas Serval, Neuilly-sur-Seine (FR); Olivier Giroud, Neuilly-sur-Seine (FR); Alexis Moine, Neuilly-sur-Seine (FR)

(21) Appl. No.: 18/574,410

(22) PCT Filed: Jun. 29, 2022
(86) PCT No.: PCT/IB2022/056084

§ 371 Date: Dec. 27, 2023

Related U.S. Application Data
(60) Provisional application No. 63/216,514, filed on Jun. 29, 2021.
(60) Provisional application No. 63/295,382, filed on Dec. 30, 2021.

(51) Int. Cl. H02J 50/00; G01K 1/024; G01K 13/20; G01P 15/105

(52) U.S. Cl. CPC H02J 50/001; G01K 1/024; G01K 13/20; G01P 15/105

(57) ABSTRACT

A device includes a real-time clock, an energy storage device, an energy harvester, a memory, a control system, and a transceiver. The real-time clock generates time data. The capacitor stores electrical power operable to power the real-time clock. The energy harvester charges the energy storage device. The memory stores machine-readable instructions. The control system includes one or more processors configured to execute the machine-readable instructions to associate the time data with motion data that is indicative of a relative orientation of the device, movement of the device, or both. The transceiver transmits at least a portion of the motion data and the associated time data to a user device.

### CROSS REFERENCE TO RELATED APPLICATIONS

This application claims the benefit of, and priority to, U.S. Provisional Patent Application No. 63/216,514, filed Jun. 29, 2021, and U.S. Provisional Patent Application No. 63/295,382, filed, Dec. 30, 2021, each of which is hereby incorporated by reference herein in its entirety.

### TECHNICAL FIELD

The present disclosure relates generally to devices that harvest energy for powering one or more components rather than using a battery, and more particularly, to devices including a real-time clock, an energy harvester, and a capacitor.

### BACKGROUND

Various devices exist for tracking motion of objects. Such devices typically include an accelerometer and/or a gyroscope and require a battery for powering these and other components. However, a battery only has a finite charge before needing to be recharged or replaced. It would be advantageous to track motion without using an accelerometer or gyroscope, and without a battery.

Similarly, various electronic devices exist for measuring temperature (e.g., the body temperature of a user, patient, or subject). Digital thermometers typically include a battery for powering the temperature sensor (e.g., an infrared sensor). In most cases, the maximum storage time for a digital thermometer does not exceed 5 years, and in cases where the digital thermometer includes a display, the typical maximum storage time is approximately 2 years. In medical environments (e.g., hospital, physician's office, etc.) the battery often needs to be replaced after approximately 2,000 to 3,000 temperature measurements. It would be advantageous to measure temperature without requiring a battery that has a finite charge before needing to be recharged ore placed. The present disclosure is directed to solving these and other problems.

### SUMMARY

According to some implementations of the present disclosure, a device includes a real-time clock, an energy storage device, an energy harvester, a memory, a control system, and a transceiver. The real-time clock generates time data. The energy storage device stores electrical power operable to power the real-time clock. The energy harvester charges the energy storage device. The memory stores machine-readable instructions. The control system includes one or more processors configured to execute the machine-readable instructions to associate the time data with motion data that is indicative of a relative orientation of the device, movement of the device, or both. The transceiver transmits at least a portion of the motion data and the associated time data to a user device.

According to some implementations of the present disclosure, a method includes prompting a user to move a motion tracking device comprising a real-time clock, an energy storage device, and an energy harvester, the energy harvester being configured to charge the energy storage device responsive to movement of the motion tracking device. The method also includes receiving, from the motion tracking device, data associated with movement of the motion tracking device. The method also includes determining whether the user performed an activity based at least in part on the data associated with movement of the motion tracking device. The method also includes causing an indication associated with the activity to be displayed on a display device responsive to determining that the user performed the activity. The method also includes associating an award with a profile associated with the user responsive to determining that the user performed the activity to aid in encouraging the user to perform the activity.

According to some implementations of the present disclosure, a system includes a motion tracking device. The motion tracking device includes a real-time clock, an energy storage device, an energy harvester, a memory, a control system, and a transceiver. The real-time clock generates time data. The energy storage device stores electrical power operable to power the real-time clock. The energy harvester charges the energy storage device. The memory stores machine-readable instructions. The control system includes one or more processors configured to execute the machine-readable instructions to associate the time data with motion data that is indicative of a relative orientation of the device, movement of the device, or both. The transceiver transmits at least a portion of the motion data and the associated time data to a user device.

According to some implementations of the present disclosure, a device includes a temperature sensor, an energy storage device, an energy harvester, a memory, and a control system. The temperature sensor is configured to generate temperature data associated with a user. The energy storage device configured to store electrical power operable to power the temperature sensor. The energy harvester is configured to charge the energy storage device. The memory stores machine readable instructions. The control system includes one or more processors configured to execute the machine-readable instructions to determine a body temperature of the user based at least in part on the temperature data.

According to some implementations of the present disclosure, a method includes prompting a user to move a measurement device to cause an energy harvester to generate energy for powering a temperature sensor of the measurement device. The method also includes prompting a user to move the measurement device to cause the temperature sensor to generate temperature data associated with a body temperature of the user. The method also includes automatically transmitting at least a portion of the temperature data from the measurement device to a user device. The method also includes causing the user device to display one or more indications indicative of the body temperature of the user based at least in part on the temperature data.

The above summary is not intended to represent each implementation or every aspect of the present disclosure. Additional features and benefits of the present disclosure are apparent from the detailed description and figures set forth below.

### BRIEF DESCRIPTION OF THE DRAWINGS

FIG. 1 is a functional block diagram of a system, according to some implementations of the present disclosure;

FIG. 2 is a perspective view of a linear actuator, according to some implementations of the present disclosure;

FIG. 3A is a perspective view of an EMF actuator, according to some implementations of the present disclosure;

FIG. 3A is a cross-sectional view of the EMF actuator of FIG. 3A, according to some implementations of the present disclosure;

FIG. 4 is a perspective view of an EMF actuator with portions removed for illustrative purposes, according to some implementations of the present disclosure;

FIG. 5 is a cross-sectional view of an EMF actuator, according to some implementations of the present disclosure;

FIG. 6 is a schematic illustration of a voltage regulator, according to some implementations of the present disclosure;

FIG. 7 is a perspective view of a motion tracking device and an object, according to some implementations of the present disclosure;

FIG. 8 is a process flow diagram for a method, according to some implementations of the present disclosure;

FIG. 9A is a front view of a device for determining a body temperature of a user, according to some implementations of the present disclosure;

FIG. 9B is a perspective view of the device of FIG. 9A with a cap removed from a housing, according to some implementations of the present disclosure;

FIG. 10 is a process flow diagram for a method, according to some implementations of the present disclosure;

FIG. 11A is a first screenshot including a temperature indication, according to some implementations of the present disclosure;

FIG. 11B is a second screenshot including a plurality indications associated with a body temperature, according to some implementations of the present disclosure;

FIG. 11C is a third screenshot including a plurality indications associated with a body temperature and a plurality of selectable symptom elements, according to some implementations of the present disclosure; and

FIG. 11D is a fourth screenshot including a temperature indication and historical temperature measurement indications, according to some implementations of the present disclosure.

While the present disclosure is susceptible to various modifications and alternative forms, specific implementations and embodiments thereof have been shown by way of example in the drawings and will herein be described in detail. It should be understood, however, that it is not intended to limit the present disclosure to the particular forms disclosed, but on the contrary, the present disclosure is to cover all modifications, equivalents, and alternatives falling within the spirit and scope of the present disclosure as defined by the appended claims.

### DETAILED DESCRIPTION

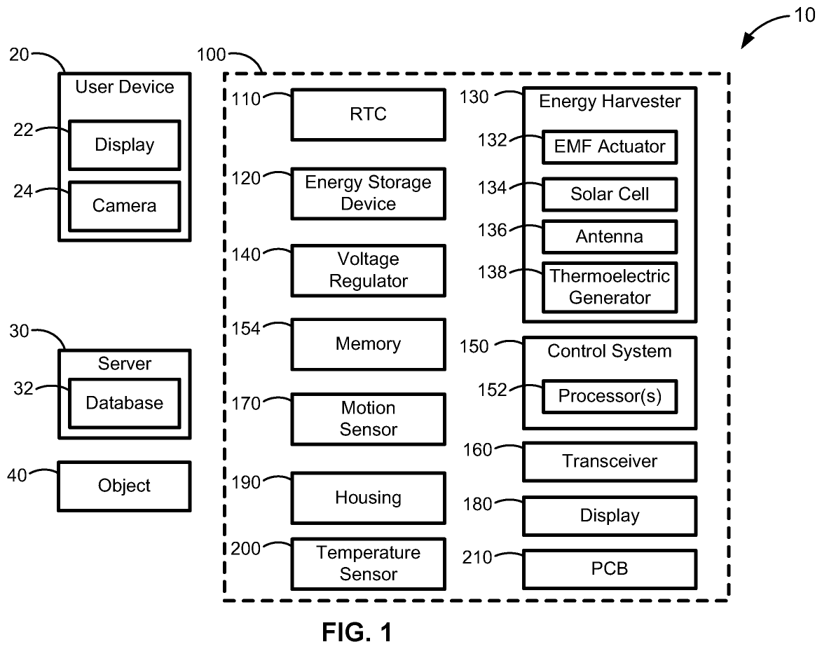

Referring to FIG. 1, a system 10 according to some implementations of the present disclosure is illustrated. The system 10 includes a measurement device 100. In some implementations, the system 10 also includes a user device 20, a server 30, an object 40, or any combination thereof. As discussed herein, the measurement device 100 can generate data (e.g., indicative of movement and/or a relative orientation of the measurement device 100, temperature data, etc.) and transmit at least a portion of that data to another device (e.g., the mobile device 20). In some implementations, the measurement device 100 can be coupled to or integrated in the object 40, such that the data indicative of movement and/or a relative orientation of the measurement device 100 is also indicative of movement and/or a relative orientation of the object 40.

The measurement device 100 includes a real-time clock (RTC) 110, an energy storage device 120, an energy harvester 130, a voltage regulator 140, a control system 150, a memory 154, a transceiver 160, a motion sensor 170, a display 180, a housing 190, a temperature sensor 200, or any combination thereof.

The real-time clock (RTC) 110 measures the passage of time and outputs time data. As The RTC 110 can be powered by the energy storage device 120. The RTC 110 is advantageous (e.g., compared to ordinary hardware clocks) in that the RTC 110 consumes minimal power during operation. For example, in some implementations, the RTC 110 requires between about 10 μW and about 1 μW to generate time data (e.g., for timestamping other data, for determining a relative orientation or movement of the measurement device 100, etc.). As also described in further detail herein, the time data generated by the RTC 110 can be associated with other data generated by one or more components of the measurement device 100. For example, other data generated by the measurement device 100 can be timestamped based on the time data from the RTC 110. The time data generated by the RTC 110 can also be used to measure or determine how long the measurement device 100 is moving (e.g., for determining a duration of an activity performed by a user moving the measurement device 100). The time data can also be used in combination with other data to determine or estimate movement and/or a relative orientation of the measurement device 100.

The energy storage device 120 stores electrical power operable to power the real-time clock 110 and other components of the measurement device 100. The energy storage device 120 can be, for example, a capacitor. In some implementations, the energy storage device 120 is a super capacitor. The c energy storage device 120 is charged by the energy harvester 130. The energy storage device 120 can store power, for example, to power the RTC 110 for a predetermined amount of time (e.g., 30 days, 90 days, 6 months, 1 year, 2 years, etc.).

In some implementations, the energy storage device 120 is a rechargeable battery. For example, the energy storage device 120 can be a fast-rechargeable solid-state micro-battery. A solid-state micro-battery generally stores a limited amount of energy (e.g., approximately 1-3 μAh), but have relatively high power density. For example, the solid-state micro-battery can have a power density between about 100 mW/cm² and about 1,500 mW/cm² and an energy density that is between about 0.5 mW.h/cm² and about 20 mW.h/cm². The solid-state micro-battery can be recharged, for example, in about 15 minutes (e.g., from about 10% capacity to approximately 80% capacity). In such implementations, the solid-state micro-battery can be surfaced mounted (e.g., soldered) to a printed circuit board (PCB) 210. One or more additional components of the device 100 can also be coupled (e.g., directly or indirectly) to the PCB 210 (e.g., the RTC 110, the voltage regulator 140, the memory 154, the energy harvester 130, the control system 150, the transceiver, or any combination thereof).

Generally, the energy harvester 130 harvests energy to charge the energy storage device 120. For example, the energy harvester 130 can harvest energy and charge the energy storage device 120 using electromagnetic induction, triboelectric charging, piezoelectricity, or any combination thereof. The energy harvester 130 can include an electromotive force (EMF) actuator 132, a solar cell 134, an antenna 136, a thermoelectric generator 138, or any combination thereof. The EMF actuator 132 generates an electromotive force (measured in volts) responsive to movement of the EMF actuator 132 (e.g., linear movement, rotational movement, or both) to charge the energy storage device 120. As described in further detail herein, the EMF actuator 132 includes one or more coils and one or more magnets for generating an EMF voltage according to Faraday's law. The solar cell 134 (also referred to as a photovoltaic cell) harvests solar energy (e.g., certain wavelengths of light) to charge the energy storage device 120. The antenna 136 is configured to receive radio-frequency (RF) energy and convert the RF energy to electrical power for charging the energy storage device 120. The RF energy captured by the antenna 136 can be between about 100 KHz and about 60 GHz, which can generate between about 2 volts and about 3 volts for recharging the energy storage device 120.

In some implementations, the energy harvester 130 optionally includes the thermoelectric generator 138. The thermoelectric generator 138 is configured to convert a temperature gradient to electrical power and deliver a voltage to the energy storage device 120. For example, the temperature gradient used by the thermoelectric generator 138 can be a temperature gradient between a temperature of a user (e.g., body temperature, skin temperature, etc.) and an ambient temperature (e.g., the ambient temperature of the environment surrounding the user).

While the energy harvester 130 is shown as including one EMF actuator 132, one solar cell 134, and one antenna 136, and one thermoelectric generator 138, more generally, the energy harvester 130 can include any suitable number or combination of these components. For example, the energy harvester 130 can include a first EMF actuator that generates EMF voltage responsive to linear movement of the measurement device 100 and a second EMF actuator that generates EMF voltage responsive to non-linear (e.g., rotational) movement of the measurement device 100.

As described above, in some implementations, the energy harvester 130 generates an EMF voltage for charging the energy storage device 120 in response to movement (e.g., linear, rotational, or both) of the measurement device 100. In such implementations, the measurement device 100 can include the voltage regulator 140 for converting the EMF generated by the energy harvester 130 to a predetermined voltage and deliver the predetermined voltage to the energy storage device 120. For example, the EMF actuator 132 may generate a variable EMF voltage due to variables in the amplitude and frequency of movement. The voltage regulator 140 can convert the variable voltage to a constant, stable voltage (or substantially constant voltage) before reaching the energy storage device 120. In some implementations, the measurement device 100 also includes a power management integrated circuit (PMIC) or a metal-oxide-semiconductor field-effect transistor (MOSFET) to regulate electrical current.

The control system 150 includes one or more processors 152 (hereinafter, processor 152). The control system 150 is generally used to control (e.g., actuate, turn on/off, etc.) the various components of the measurement device 100 and/or analyze data obtained and/or generated by the components of the measurement device 100. The processor 152 can be a general or special purpose processor or microprocessor. While one processor 152 is illustrated in FIG. 1, the control system 150 can include any number of processors (e.g., one processor, two processors, five processors, ten processors, etc.) that can be in a single housing, or located remotely from each other. The control system 150 (or any other control system) or a portion of the control system 150 such as the processor 152 (or any other processor(s) or portion(s) of any other control system), can be used to carry out one or more steps of any of the methods described and/or claimed herein. The control system 150 can be coupled to and/or positioned within, for example, the housing 190 of the measurement device 100, or outside of the measurement device 100 (e.g., within a housing of the user device 20 and/or the object 40). The control system 150 can be centralized (within one such housing) or decentralized (within two or more of such housings, which are physically distinct). In such implementations including two or more housings containing the control system 150, such housings can be located proximately and/or remotely from each other.

The memory device 154 stores machine-readable instructions that are executable by the processor 152 of the control system 150. The memory device 114 can be any suitable computer readable storage device or media, such as, for example, a random or serial access memory device, a hard drive, a solid state drive, a flash memory device, etc. While one memory device 154 is shown in FIG. 1, the measurement device 100 can include any suitable number of memory devices 154 (e.g., one memory device, two memory devices, five memory devices, ten memory devices, etc.). The memory device 154 can be coupled to and/or positioned within the housing 190 of the measurement device 100 or outside of the measurement device 100. Like the control system 150, the memory device 154 can be centralized (within one such housing) or decentralized (within two or more of such housings, which are physically distinct).

The transceiver 160 is generally used to transmit data from the measurement device 100 to another device (e.g., the user device 20) and/or receive data from another device (e.g., the user device 20). The transceiver 160 can be powered by the energy storage device 120. The transceiver 160 can communicate with the user device 20 using a variety of wireless communication protocols. For example, in some implementations, the transceiver 160 includes a radio-frequency identification (RFID) chip, a near-field communication (NFC) chip, a Bluetooth Low Energy (BLE) chip, or any combination thereof. In such implementations, a user may need to bring the measurement device 100 within a predetermined proximity of the device that information is to be transmitted to (e.g., the user device 20). In other implementations, the transceiver 160 includes a speaker configured to emit sound waves for transmitting the data (e.g., motion data and/or time data) from the measurement device 100 to another device (e.g., the user device 20). In such implementations, the speaker can emit near-ultrasonic sound waves that are inaudible to the human ear to transmit data. For example, data (e.g., time data or timestamp information) can be encoded using the near-ultrasonic waves (e.g., using Morse code) for transmission to another device (e.g., the user device 20). Alternatively, in some implementations, the transceiver 160 is configured to communicate with another device external to the measurement device 100 (e.g., the user device 20) using light. For example, the transceiver 160 can communicate with the user device 120 via a Li-FI connection or protocol or infrared (e.g., an IrDa protocol). More generally, the transceiver 160 can also transmit data using any low power, low cost, and low bandwidth communication protocol or system (e.g., Zigbee).

In some implementations, the transceiver 160 is actuated responsive to sufficient power being stored in the energy storage device 120 (e.g., a predetermined voltage threshold is reached). Generally, the transceiver 160 draws more power from the capacitator 120 than the RTC 110. Thus, it is advantageous to deactivate or turn off the transceiver 160 when it is not in operation (e.g., not needed to transmit data).

The motion sensor 170 generates motion data indicative of a relative orientation (e.g., pitch, roll, yaw) of the measurement device 100 and/or movement of the measurement device 100 relative to a reference frame. In some implementations, the motion sensor 170 is a microelectromechanical (MEMS) sensor (e.g., a 6-axis MEMS sensor). In some implementations, the motion sensor 170 is an analog-digital converter (ADC) that measures the amplitude of the EMF voltage generated by the EMF actuator 132 responsive to movement of the measurement device 100. Based on the measured EMF voltage, motion of the magnet contained within the EMF actuator 132 can be estimated or determined, and in turn a relative orientation of the measurement device 100 (e.g., pitch angle), can be estimated or determined (e.g., by the control system 150). In some implementations, the motion sensor 170 does not include an accelerometer or a gyroscope.

The display 180 can be used to display, for example, images, alphanumeric text, or both. The display 180 can be an LED display, an OLED display, an LCD display, an electrophoretic display, a memory-in-pixel display, a segment LCD display, or the like. In some implementations, the display 180 is coupled to or protrudes from an exterior of the housing 190. In some implementations, the display 180 is an electrophoretic display.

One or more of the components of the measurement device 100 can be at least partially disposed within the housing 190. In some implementations, the housing 190 is generally cylindrical. In such implementations, the housing 190 can be sized and shaped as a AA or a AAA battery (or any other suitable battery size) so that, for example, the measurement device 100 can be positioned in a compartment for a battery. In other words, in such implementations, the measurement device 100 can be used in an electronic device as a substitute for a battery. For example, the housing can have a length of about 1.75 inches and a diameter of about 0.4 inches (e.g., consistent with the size and shape of a AA battery). As another example, the housing can have a length of about 1.75 inches and a diameter of about 0.4 inches (e.g., consistent with the size and shape of a AAA battery).

In some implementations, the transceiver 160 of the measurement device 100 can communicate with the user device 20. The user device 20 can be, for example, a mobile device such as a smart phone, a tablet, a gaming console, a smart watch, a laptop, a television (e.g., a smart television), a smart home device (e.g., a smart speaker), a wearable device (e.g., smart watch) or the like. The display device 22 is generally used to display image(s) including still images, video images, or both. In some implementations, the display device 22 acts as a human-machine interface (HMI) that includes a graphic user interface (GUI) configured to display the image(s) and an input interface. The display device 22 can be an LED display, an OLED display, an LCD display, or the like. The input interface can be, for example, a touchscreen or touch-sensitive substrate, a mouse, a keyboard, or any sensor system configured to sense inputs made by a human user interacting with the user device 20. The user device 20 further includes a camera 24 that is configured to generate image data reproducible as one or more images (e.g., still images, video images, or both). For example, the camera 24 can be used to generate images of a user of the user device 20, a user of measurement device 100, at least a portion of the measurement device 100 itself, or any combination thereof. In some implementations, one or more user devices can be used by and/or included in the system 10.

The server 30 can communicate with the user device 20 (e.g., via the Internet, a cellular device, etc.) to receive data from the user device 20 (e.g., data from the measurement device 100) or transmit data to the user device 20. The server 30 includes a database 32 for storing user profiles associated with a plurality of users. For example, the database 32 can store a user profile associated with a user of the measurement device 100. The user profile can include, for example, demographic information associated with the user (e.g., name, age, gender, etc.). The user profile can also include data from the measurement device 100 when used by the associated user. For example, as described herein, responsive to determining that the user performed an activity based on data from the measurement device 100, the user profile associated with that user can be associated with or updated with an award. The award can be in the form of points (e.g., that can be redeemed for physical prizes or goods), badges, trophies, or the like. The award(s) generally aid in encouraging or motivating the user to regularly perform the activity.

In some implementations, the measurement device 100 can be coupled to or integrated in the object 40. In some implementations, the object 40 is a portion of a user (e.g., the measurement device 100 is implanted inside a portion of a user) or integrated in or coupled to the object 40, which in turn is worn by the user. For example, the object 40 can be a shoe or other footwear worn by the user, and the measurement device 100 can be used to measure foot movement and/or pressure in accordance with the principles described herein. As another example, the measurement device 100 can be used as a heart monitoring system. In this example, the energy harvester 130 harvests energy for charging the energy storage device 120 from movements of the user, and collects physiological data (e.g., heart rate) at a predetermined interval (e.g., every hour). Similarly, the measurement device 100 can be used to track activity of the user (e.g., sports, running, therapy, etc.). In one example, the object 40 is a weight or other exercise equipment to which the measurement device 100 is coupled or disposed within. In other implementations, the object 40 to which the measurement device 100 is coupled to or integrated in is a moveable object, such as a vehicle, bicycle, stroller, scooter, etc. In these examples, the energy harvester 130 can harvest energy from movement of the object 40, and the measurement device 100 more generally can be used to track movement of the object 40. In still other implementations, the object 40 to which the measurement device 100 is coupled or integrated in is a tag that can be coupled or another object (e.g., a water bottle) or worn by a user (e.g., on the wrist). In such implementations, the energy harvester 130 charges the energy storage device 120 as the object 40 is moved. A light is actuated (e.g., on the display 180) at a predetermined interval (e.g., every 5 minutes, every 10 minutes, every 45 minutes, every 2 hours, etc.) to remind the user to perform an activity (e.g., hand washing). The measurement device 100 can be used in such implementations to verify that the user performed the activity.

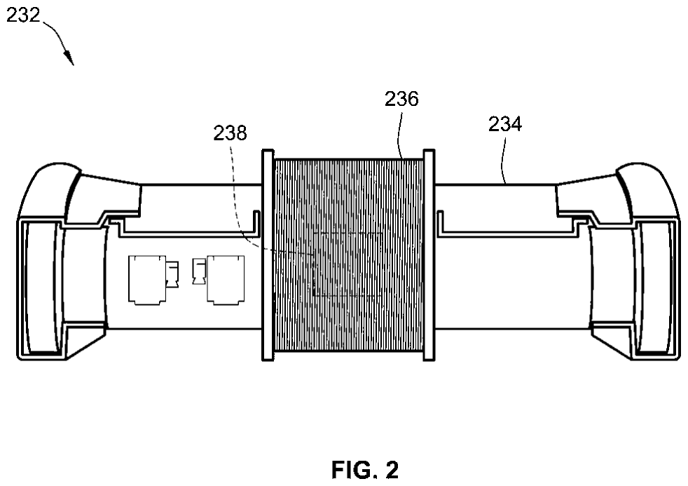

Referring to FIG. 2, an EMF actuator 232 according to some implementations of the present disclosure is illustrated. The EMF actuator 232 is the same as, or similar to, the EMF actuator 132 (FIG. 1) described above and is generally used to generate an EMF voltage. More specifically, the EMF actuator 232 includes a cylinder 234, a coil 236, and a magnet 238. The coil 236 surrounds a portion of the cylinder 234 (e.g., a generally center portion of the cylinder 234). The magnet 238 is disposed within the cylinder 234 such that the magnet 238 is freely moveable relative to the coil 236 responsive to linear movement of the cylinder 234. Movement of the magnet 238 relative to the coil 236 generates the EMF voltage according to Faraday's law. The EMF voltage (E) is proportional to the number of spires (N) in the coil 236, the magnetic field (B) of the magnet 238, the surface(S) of the spires, and the typical time (T) the magnet 238 takes move from one end of the coil 236 to the other opposing end of the coil 236. This relationship is expressed in Equation 1 below:

$$E = \frac{N \times B \times S}{T}$$

Accordingly, the EMF voltage output by the EMF actuator 232 can be selected based on or by modifying one or more of the variables in Equation 1.

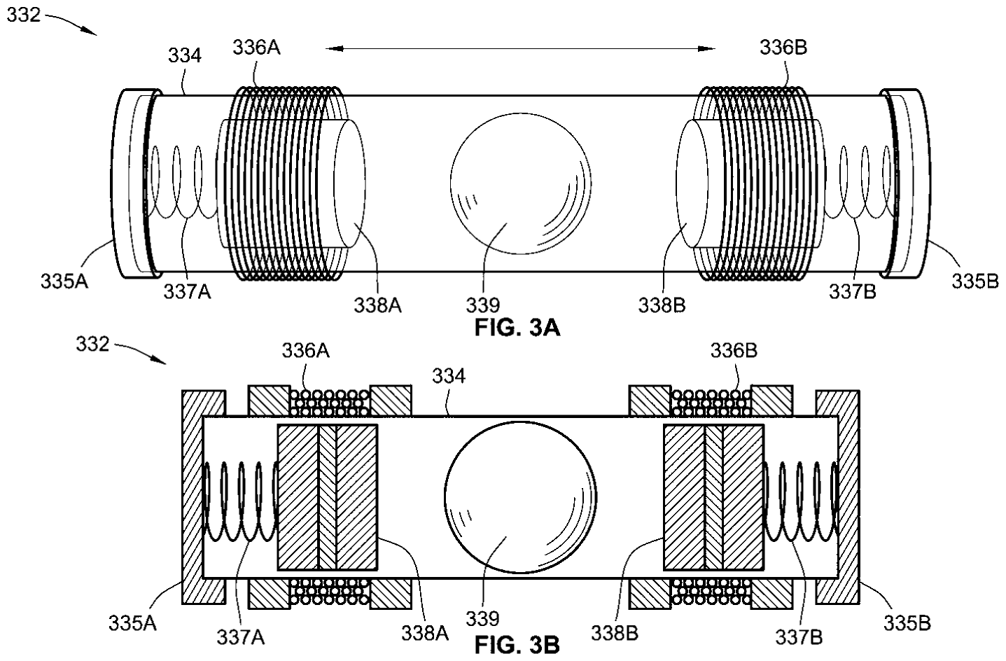

Referring to FIGS. 3A and 3B, an EMF actuator 332 according to some implementations of the present disclosure is illustrated. The EMF actuator 332 is similar to the EMF actuator 232 (FIG. 2) described above and is generally used to generate an EMF voltage responsive to linear movement. The EMF actuator 332 includes a cylindrical housing, a first coil 336A, a second coil 336B, a first magnet 338A, a second magnet 338B, and an inertial mass 339. The first coil 336A is generally positioned to at least partially surround the first magnet 338A. Similarly, the second coil 336B is generally positioned to at least partially surround the second magnet 338B. The first magnet 338A is coupled to a first end cap 335A of the housing 334 via a first helical compression spring 337A. Similarly, second magnet 338B is coupled to a second end cap 335B of the housing 334 via a second helical compression spring 337B. The inertial mass 339 is generally spherically and is moveable within the cylindrical housing 334A. For example, in response to movement of the EMF actuator 332A, the inertial mass 339A can move towards the first end cap 335A and contact the first magnet 338A. While the first helical compression spring 337A urges the first magnet 338A generally away from the first end cap 335A towards the second end cap 335B, the inertial mass 339 can move the first magnet 338A towards the first end cap 335A relative to the first coil 336A to generate an EMF voltage. The inertial mass 339 can also move the second magnet 338B relative to the second coil 336B in the same or similar manner.

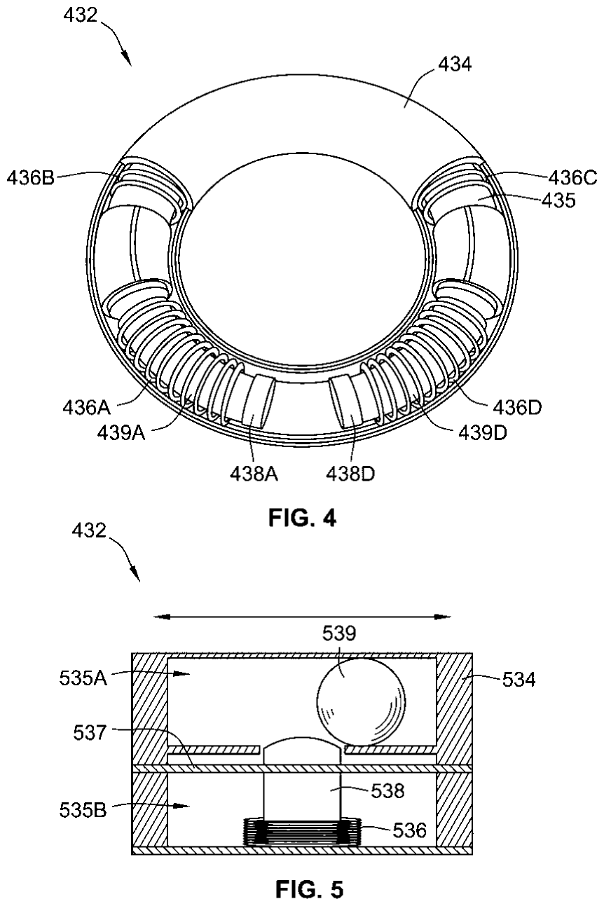

Referring to FIG. 4, an EMF actuator 432 according to some implementations of the present disclosure is illustrated. The EMF actuator 432 is similar to the EMF actuator 232 (FIG. 2) and the EMF actuator 332 (FIGS. 3A-3B) in that it generates an EMF voltage responsive to movement of the measurement device 100. However, the EMF actuator 432 differs in that it generates the EMF voltage responsive to rotational movement of the measurement device 100 (e.g., as opposed to linear movement). The EMF actuator 432 includes an outer shell 434, inner tubing 435, a plurality of coils 436A-436D, a plurality of magnetic cores 438A-438D, and a plurality of movers 439A-439D. Movement of movers 439A-439D, in which the magnetic cores 438A-438D are positioned, relative to the coils 436A-436D generates an EMF voltage responsive to rotation of the EMF actuator 432.

Referring to FIG. 5, an EMF actuator 532 according to some implementations of the present disclosure is illustrated. The EMF actuator 532 is similar to the EMF actuator 432 (FIG. 4) in that it generates an EMF voltage responsive to rotational movement of the measurement device 100. The EMF actuator 532 includes a housing 534 including an upper cavity 535A and a lower cavity 535B. The EMF actuator 532 also includes a coil 536 surrounding a portion of a magnet 538. The magnet 538 is positioned in the lower cavity 535B and includes a proof-mass with a parabolic top that protrudes into the upper cavity 535A. The EMF actuator 532 also includes a cantilever beam 537 in the lower cavity 535B and a moveable, spherical ball 539 in the upper cavity 535A. Movement of the spherical ball 539 over the parabolic top coupled to the magnet 538 causes the magnet 538 to move relative to the coil 536, inducing an EMF voltage in accordance with the principles described herein.

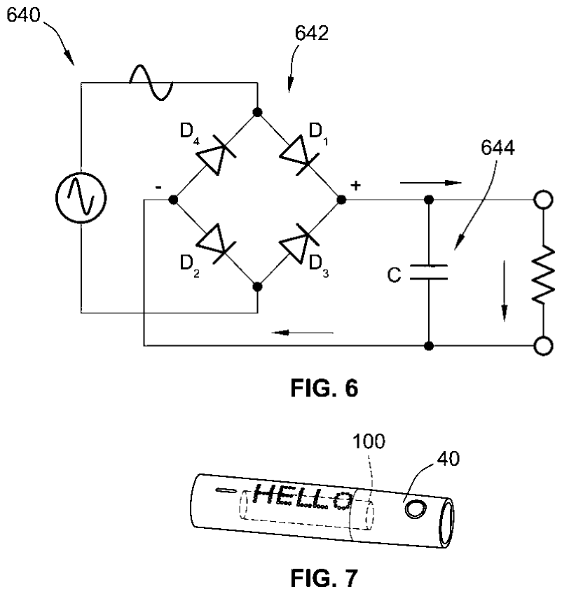

Referring to FIG. 6, a voltage regulator 640 according to some implementations of the present disclosure is illustrated. The voltage regulator 640 is the same as, or similar to, the voltage regulator 140 described above. The voltage regulator 640 includes a bridge rectifier 642 comprising four diodes and a capacitor 644. As discussed above, in some implementations, the energy harvester 130 for charging the energy storage device 120 includes an EMF actuator 132 (FIG. 1) for generating an EMF voltage. This EMF voltage may fluctuate (e.g., is not constant) as the amplitude depends at least part on motion of the EMF actuator 132 (e.g., motion with higher frequency or amplitude can generate a higher EMF voltage). The voltage regulator 640 receives the variable EMF voltage from the EMF actuator 130 and delivers a constant, stable voltage to the energy storage device 120 for charging.

As described herein, in some implementations, the measurement device 100 can be coupled to or at least partially disposed within an object. Referring to FIG. 7, the measurement device 100 is disposed within a housing of an object 700. In this example, the object 700 is a handle that is configured to be gripped by a user in performing one or more activities.

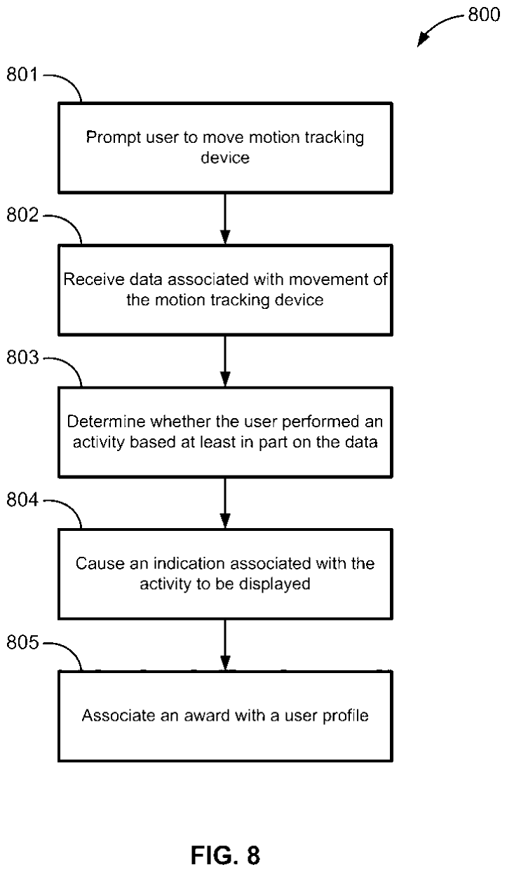

Referring to FIG. 8, a method 800 according to some implementations of the present disclosure is illustrated. One or more steps or aspects of the method 700 can be implemented using any element or aspect of the system 10 (FIGS. 1-7) described herein.

Step 801 of the method 800 includes prompting a user to move a motion tracking device (e.g., the measurement device 100). As described herein, the energy harvester 130 charges the energy storage device 120 responsive to movement of the measurement device 100. Accordingly, to charge the energy storage device 120, the user is prompted to move the measurement device 100. For example, the user can be prompted to move (e.g., shake) the measurement device 100 for a predetermined amount of time (e.g., at least 10 seconds). The prompt(s) can be displayed, for example, using the display 22 of the user device 20. The prompt(s) can include alphanumeric text instructing the user to move the measurement device 100 and/or a video or animation showing the user how to move the measurement device 100. The prompt(s) can further include a progress bar to inform the user how to long to move the measurement device 100. The prompt(s) can additionally include audio for instructing the user (e.g., played via a speaker of the user device 20). In some implementations, step 801 can include prompting the user to bring the measurement device 100 or the object to which the measurement device 100 is coupled within a predetermined proximity to the user device 20.

In some cases, the user may not move the measurement device 100 sufficiently for the energy harvester 130 to charge the energy storage device 120. Thus, in some implementations, if the energy storage device 120 is not sufficient charged within a predetermined time of the user being prompting to move the measurement device 100, step 801 can include modifying the prompt to further instruct the user to move the measurement device 100 (e.g., shake the device faster, shake the device harder, etc.).

Step 802 of the method 800 includes receiving data associated with movement of the motion tracking device. The data can include, for example, time data generated by the RTC 110 (FIG. 1), motion data from the motion sensor 170 (which can include measurements of the EMF voltage generated by the EMF actuator 132), or both. The data can be received by, for example, the memory 154 of the measurement device 100, the user device 20, the server 30, or any combination thereof. For example, the data can be stored in the memory 154 of the measurement device 100, then transmitted by the transceiver 160 to the user device 20. The data can then be subsequently transmitted from the user device 20 to the server 30.

Step 803 of the method 800 includes determining whether the user performed an activity based at least in part on the received data (step 802). As described herein, a relative orientation and/or movement (e.g., relative to a reference frame) of the measurement device 100 can be determined or estimated in a variety of ways. For example, a relative orientation of the measurement device 100 can be determined based on time data from the RTC 110 and the measured EMF voltage provided by the energy harvester 130. This determination can be made by, for example, the control system 150, the user device 20, or the server 30. In examples where movement is determined relative to a reference frame, the user can be prompted to initiate movement at a predetermined location or origin.

In some implementations, the determined relative orientation and/or movement of the measurement device 100 can be compared to previously-recorded data associated with the activity to determine whether the user is performing the activity. This previously-recorded data can be stored in the database 32 of the server 30, the user device 20, or the memory 154. The previously-recorded data be associated with the user (e.g., a prior instance where the user performed the activity, for example, during a calibration step) or multiple users (e.g., prior instances where multiple users other than the user performed the activity). For instance, in some implementations, the user can be prompted to perform an activity to calibrate the measurement device 100, then subsequent motion data can be compared to the calibration data to determine whether the user performed the activity.

In some implementations, step 803 includes determining a percentage likelihood that the user performed the activity. In such implementations, a statistical analysis can be used to determine the percentage likelihood or a confidential interval (e.g., 95%, 90%, 85%, or other suitable certainty). The statistical analysis can include principal component analysis (PCA), hierarchical cluster analysis (HCA), regression analysis, linear discriminant analysis, or any combination thereof.

Step 804 of the method 800 includes causing an indication associated with the activity to be displayed. The indication can be displayed, for example, using the display 22 of the user device 20. For example, the indication can communicate to the user that the activity has been completed (e.g., via alphanumeric text) and then can be stored in the user profile associated with the user.

Step 805 of the method 800 includes associating an award with a user profile associated with the user. As described above, the user of the measurement device 100 can be associated with a user profile (e.g., that is stored in the database 32 of the server 30). Responsive to determining that the user preformed the activity, the user profile stored in the database 32 of the server 30 can be associated with an award (e.g., points that can be redeemed, a trophy, a badge, etc.). The award aids in encouraging or motivating the user to perform the activity. For example, if the award includes points that can be redeemed for physical items (e.g., consumer goods), the user will be motivated to perform the activity repeatedly (e.g., daily) to accumulate points that can be redeemed for an item the user desires. In some implementations, the user receives the same amount of points (e.g., 100) each time they perform the same activity. Alternatively, the user can receive a different amount of points each time they perform the same activity. For example, the amount of points awarded for an award can progressively increase each time the user performs the activity (e.g., for successive days, weeks, months, etc.). In some implementations, an indication associated with the award can be communicated to the user, for example, using the display 22 of the user device 20.

In some implementations, the user can share the award(s) with third parties (e.g., friends, family, etc.) through the user device 20. For example, a child who earns award(s) can share this information with a parent or guardian to show that they are performing the activity. As another example, each user with a user profile in the database 32 can view the award(s) earned by other individuals. In this manner, the sharing of award(s) can further motivate the user to perform the activity.

Referring back to FIG. 1, in some implementations, the measurement device 100 includes the temperature sensor 200. The temperature sensor 200 outputs temperature data that can be stored in the memory device 154 and/or analyzed by the processor 152 of the control system 150. In some implementations, the temperature sensor 200 generates temperatures data indicative of a core body temperature of a user, a skin temperature of the user, an ambient temperature, or any combination thereof. In some implementations, the temperature sensor 200 is a thermopile infrared sensor. Alternatively, the temperature sensor 200 can be, for example, a thermocouple sensor, a thermistor sensor, a silicon band gap temperature sensor or semiconductor-based sensor, a resistance temperature detector, or any combination thereof. The temperature sensor 200 can be configured to measure temperatures between, for example, about 35 degrees Celsius (about 95 degrees Fahrenheit) and about 43.2 degrees Celsius (about 109.8 degrees Fahrenheit) with a resolution of about 0.1 degrees Celsius (or about 0.1 degrees Fahrenheit). In examples where the temperature sensor 200 is used to measure a body temperature of a user, the clinical accuraty of of the temperature sensor can be, for example, about +0.2 degrees Celsius (about ±0.4 degrees Fahrenheit).

In some implementations, the measurement device 100 includes one or more of the RTC 110, the energy storage device 120, the energy harvester 130, the control system 150, the transceiver 160, the display 180, the housing 190, and the temperature sensor 200. In such implementations including the temperature sensor 200 (e.g., but not including the motion sensor 170), the measurement device 100 can be used to measure a temperature (e.g., body temperature) of a user of the measurement device 100 (or another patient or subject). For example, the user can bring the temperature sensor 200 into contact with a portion of the user (e.g., the forehead of the user) to measure the body temperature of the user.

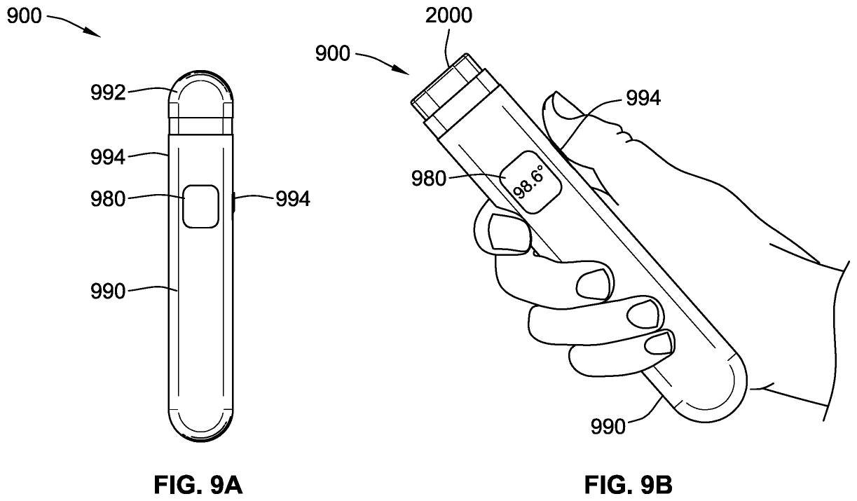

For example, referring to FIGS. 9, a measurement device 900 according to some implementations of the present disclosure is illustrated. The measurement device 900 that is the same as, or similar to, the measurement device 100 and is generally used to measure a body temperature (e.g., the body temperature of the user of the measurement device 900). The measurement device 900 includes a display 980, a housing 990, and a temperature sensor 2000 that are the same as, or similar to, the display 180, the housing 190, and the temperature sensor 200 (FIG. 1) described above. The measurement device 900 also includes a real-time clock (RTC), a capacitor, an energy harvester, a voltage regulator, a control system, a memory, a transceiver, or any combination thereof, which are the same as, or similar to, the RTC 110, the energy storage device 120, the voltage regulator 140, the control system 150, the memory 154, the transceiver 160, the display 180, and the housing 190 (FIG. 1) described above. These components are disposed within the housing 990. In some implementations, the measurement device 900 has a length of about 175 mm, a width of about 30 mm, a thickness of about 22 mm, and a weight of about 130 grams.

The housing 990 differs from the housing 190 (FIG. 1) in that the housing 990 includes a cap 992 that can enclose the temperature sensor 2000 when the measurement device 900 is not in use. The housing 990 also includes a power switch 994 that is moveable (e.g., slidable) relative to the rest of the housing 990 and is configured to turn the measurement device 900 on or off. The power switch 994 can include an indicator (e.g., an LED light) to indicating whether the measurement device 900 is on or off. In some implementations, the housing 990 comprises an ABS PC recycled plastic material. In some implementations, the display 980 is an electrophoretic display that can display the temperature of the user of the measurement device 900 based on data from the temperature sensor 2000. In other implementations, the display 980 is a memory-in-pixel display or a segment LCD display. The memory-in-pixel display is advantageous compared to other displays in that it uses less power; however, the memory-in-pixel display is more expensive than, for example, an electrophoretic display or a segment LCD display. The segment LCD display (sometimes referred to as a static display or glass-only display) is advantageous in that although it uses more power than a memory-in-pixel display, it is less expensive.

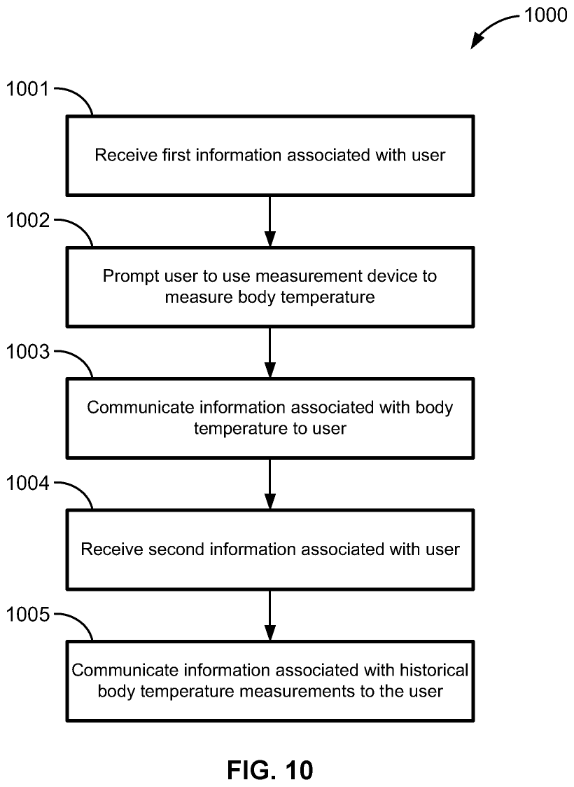

Referring to FIG. 10, a method 1000 for measuring a temperature of user according to some implementations of the present disclosure is illustrated.

Step 1001 of the method 1000 includes receiving first information associated with a user, for example, to generate a profile associated with the user. The first information can be received, for example, via the user device 20 (e.g., via alphanumeric text or other inputs). The profile can be stored in memory on the measurement device, a user device, a server, or any combination thereof. The user profile can include, for example, a name of the user, demographic information associated with the user, biometric information associated with the user, medical information associated with the user, historical body temperature information, or any combination thereof. The demographic information can include, for example, information indicative of an age of the user, a gender of the user, a race of the user, a family medical history, or any combination thereof. The medical information can include, for example, information indicative of one or more medical conditions associated with the user, medication usage by the user, or both.

Step 1002 of the method 1000 includes prompting the user to use a measurement device (e.g., the measurement device 900) to measure the body temperature of the user. In particular, the user can be prompted to move (e.g., shake the measurement device 900 to generate power via the energy harvester, to place the temperature sensor 200 on or near a portion of the user (e.g., forehead), or both. The prompt(s) can be communicated to the user via any suitable medium, such as, for example, via alphanumeric text, images, videos, animations, audio, or any combination thereof.

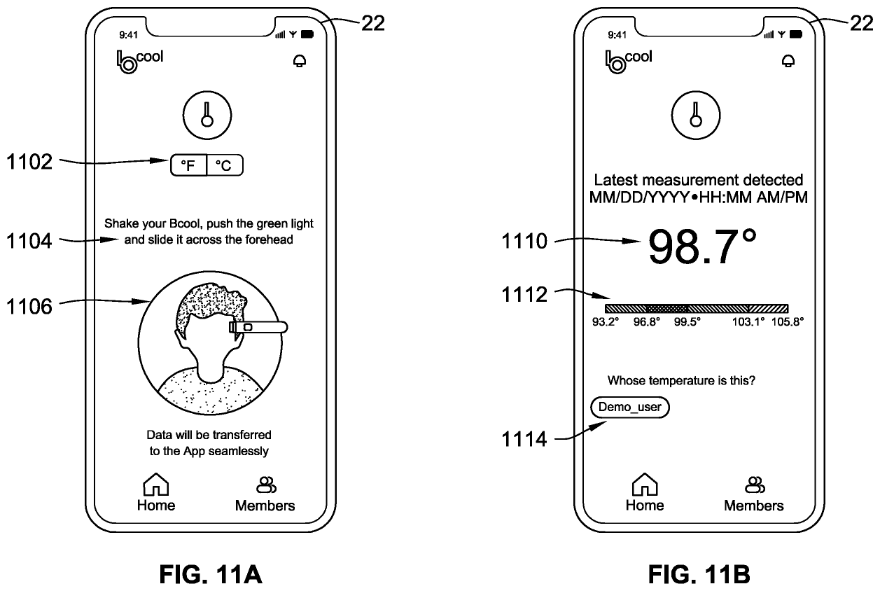

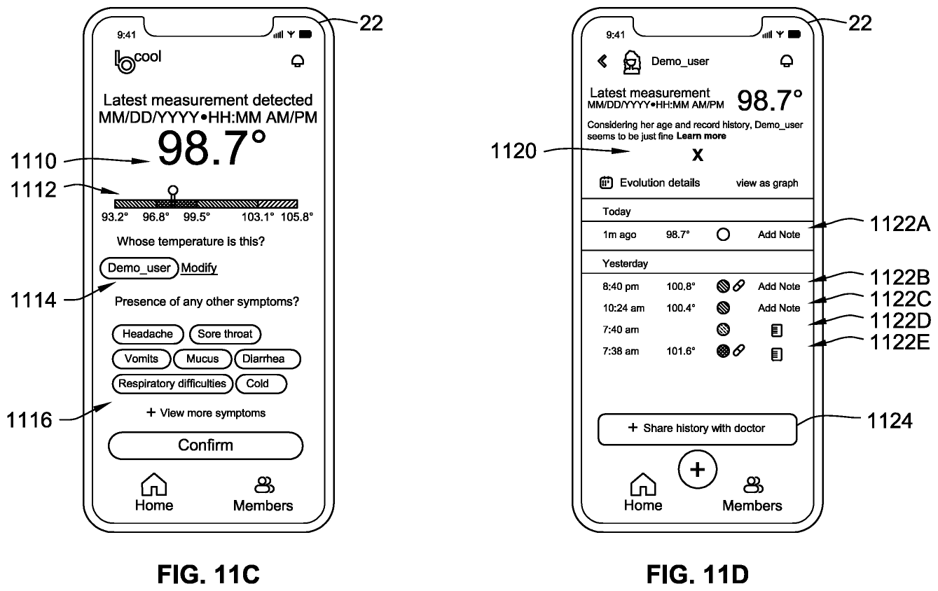

For example, referring to FIG. 11A, step 1002 can including causing the display 22 of the user device 20 to display one or more prompts, including a textual prompt 1104, a graphical prompt 1106, or both. The textual prompt 1104 can include alphanumeric text instructing the user how to use the measurement device 900 to measure body temperature (e.g., “Shake your device, push the green light, and slide it across the forehead”). The graphical prompt 1106 shows the user how to measure body temperature using an image, a video, or animation. For example, the graphical prompt 1106 can include a pre-recorded video or animation showing how to slide the measurement device 900 across the forehead (e.g., a video of an actual person using the measurement device or an animation showing a likeness of a person using the measurement device). In some implementations, the graphical prompt 1106 can include a live image or video of the user (e.g., taken via the camera 24 of the user device 20) and a representation of the measurement device 900 is overlaid on the image or video of the user (e.g., augmented reality). Step 1002 can also include displaying a unit element 1102 for toggling between temperature readouts in degrees Celsius (C) and Fahrenheit (F). In other implementations, the user can be prompted to move (e.g., shake) the measurement device 900 using one or more prompted printed on the measurement device 900 and/or in a separate user manual.

Step 1002 can also include communicating one or more prompts or indications to the user to stop any of the prompted tasks. For example, after prompting the user to move (e.g., shake) the measurement device 900 so that the energy harvester sufficiently powers the temperature sensor, step 1002 can include prompting the user to cease movement of the measurement device. Similarly, after prompting the user to measure body temperature, step 1002 can include prompting the user to cease movement of the measurement device 900 across the forehead after the measurement is completed.

Step 1003 of the method 1000 includes communicating information associated with the measured body temperature to the user. Information associated with the measured body temperature can be communicated to the user via any suitable medium, such as, for example, via displayed alphanumeric text, displayed image(s), displayed video(s), audio, or any combination thereof. In some implementations, the measured body temperature can be displayed via the display 980 of the measurement device 900, as shown in FIG. 9.

In some implementations, information associated with the measured body temperature is displayed via the display device 22 of the user device 20. In such implementations, step 1003 includes automatically transmitting temperature data from the measurement device 900 to the user device 20 subsequent to the measurement. For example, the control system of the measurement device 900 can determine the body temperature based on the data from the temperature sensor 2000 and transmit the determined body temperature to the user device 20. Alternatively, the measurement device 900 can transmit data from the temperature sensor 2000 to the user device 20, and the user device 20 determines the body temperature based on data from the temperature sensor 2000.

Referring to FIG. 11B, step 1003 can include causing a temperature indication 1110 and/or a temperature scale 1112 to be displayed on the display 22 of the user device 20. The temperature indication 1110 includes the determined body temperature of the user (e.g., 97.8 degrees Fahrenheit). The temperature indication 1110 can also the date (e.g., expressed as MM/DD/YYYY) and time (e.g., expressed as HH: MM AM/PM) that the associated temperature measurement was taken.

The temperature scale 1112 is generally indicative of normal or healthy body temperature and unhealthy body temperature (e.g., too high or too low). As one non-limiting example, the temperature scale 1112 can indicate that (1) a body temperature between about 96.6 degrees F. and about 99.5 degrees F. is in a healthy or normal (e.g., average) range, (2) a body temperature between about 93.2 degrees F. and about 96.8 degrees F. is below the normal range, (3) a body temperature between about 99.5 degrees F. and about 103.1 degrees F. is above the normal range, and (4) a body temperature between about 103.1 degrees F. and about 105.8 degrees F. is well above the normal range. Each range of body temperatures can be represented by a color on the temperature scale 1112; for example, green can be used for the normal range, yellow can be used for ranges slightly above or below the normal range, and red can be used for the ranges well above or below the normal range. These colors aid the user in understanding the health import of the temperature indication 1110 to, for example, determine whether to seek medical attention, take medication (e.g., a fever reducer), or otherwise take action(s) to reduce their body temperature (e.g., by ceasing or lower activity, moving to a location with a lower ambient temperature, etc.). In some implementations, the normal or health thresholds in temperature scale 1112 are determined based at least in part on the profile associated with the user (e.g., the age of the user, the gender of the user, the weight or height of the user, medical conditions, etc.).

Step 1004 of the method 1000 includes receiving second information associated with the user. The second information can include confirmation of the user associated with the body temperature measurement. For example, referring to FIG. 11C, one or more profile selectable elements 1114 can be displayed on the display 22. The measured body temperature is associated with a user profile responsive to a selection (e.g. click or tap) of the one of profile selectable elements 1114 associated with that profile. In this way, the measurement device 900 can be used by multiple individuals and the body temperature data can be associated with the correct individual. This portion of step 1004 can occur before the body temperature measurement, after the body temperature measurement, or both.

The second information received in step 1004 can also be associated with, for example, symptoms (or the lack thereof) experienced by the user at or around the time of the body temperature measurement. For example, referring to FIG. 11C, one or more symptom selectable elements 1116 can be displayed on the display 22. The user can select (e.g., click or tap) one or more symptom selectable elements 116 to indicate which symptoms (if any) were experienced at or around the time of the body temperature measurement. For example, the user can indicate whether they experienced headache, sore throat, vomiting, mucus, diarrhea, respiratory difficulties, cold, chills, sweating, or any combination thereof at or around the time of the body temperature measurement. This symptom information can be received before or after the body temperature measurement.

Step 1005 of the method 1000 includes communicating information associated with historical body temperature measurements to the user. For example, referring to FIG. 11D, step 1005 can include displaying a latest temperature measurement indication 1120 and a plurality of historical temperature measurement indications 1122A-1122E. The latest temperature measurement indication 1120 include information associated with the most recent temperature measurement for the user (e.g., the measured temperature, the date, the time, etc.). The plurality of historical temperature measurement indications 1122A-1122E include information associated with previously recorded temperature measurements, such as, for example, the date, the time, the body temperature, an indication associated with whether the body temperature was normal, slightly above/below normal, or well above/below normal (e.g., expressed via a green, yellow, or red symbol or shape), an indication associated with whether the user took medication (e.g., fever reducer) at or around the time of the associated measurement (e.g., expressed via a pill-shaped symbol), other notes, or any combination thereof.

Rather than listing historical temperature measurements with the indications 1122A-1122E, such information can be displayed graphically. Step 1005 can include displaying a selectable graph element (e.g., with the text “View as graph”) that can be selected (e.g., clicked or tapped) by the user to cause a graph of historical temperature data to be displayed (e.g., a line graph or plot, a bar graph or plot, etc.).

Step 1005 can further include displaying a selectable share element 1124 that can be selected (e.g., clicked or tapped) by the user to cause one or more of the latest temperature measurement and the historical temperature measurements to a third party (e.g., a medical provider). The information can be transmitted from the user device 20 to the third party via the server 30 (FIG. 1).

One or more elements or aspects or steps, or any portion(s) thereof, from one or more of any of claims 1-106 below can be combined with one or more elements or aspects or steps, or any portion(s) thereof, from one or more of any of the other claims 1-106 or combinations thereof, to form one or more additional implementations and/or claims of the present disclosure.

While the present disclosure has been described with reference to one or more particular embodiments or implementations, those skilled in the art will recognize that many changes may be made thereto without departing from the spirit and scope of the present disclosure. Each of these implementations and obvious variations thereof is contemplated as falling within the spirit and scope of the present disclosure. It is also contemplated that additional implementations according to aspects of the present disclosure may combine any number of features from any of the implementations described herein.

1-61. (canceled)

62. A system comprising:
a motion tracking device including:
a real-time clock configured to generate time data;
an energy storage device configured to store electrical power operable to power the real-time clock;
an energy harvester configured to charge the energy storage device;
a memory storing machine readable instructions;
a control system including one or more processors configured to execute the machine-readable instructions to associate the time data with motion data that is indicative of a relative orientation of the device, movement of the device, or both; and
a transceiver.

63. The system of claim 62, further comprising an object, wherein the motion tracking device is coupled to the object.

64. The system of claim 62, further comprising an object, wherein the motion tracking device is at least partially disposed within a portion of the object.

65. The system of claim 62, further comprising a user device, wherein the transceiver is configured to transmit at least a portion of the motion data and the associated time data to the user device.

66. The system of claim 65, wherein the user device is a smartphone or a tablet.

67. The system of claim 66, wherein the user device includes a display device configured to display an indication associated with the relative orientation of the device, movement of the device, or both.

68. The system of claim 65, wherein the control system of the motion tracking device is configured to determine whether a user of the motion tracking device performed an activity based at least in part on the motion data and the associated time data.

69. The system of claim 65, wherein a user device is configured to determine whether a user of the motion tracking device performed an activity based at least in part on the transmitted motion data and the associated time data from the motion tracking device.

70. The system of claim 68, further comprising a server including a database, wherein the user device is configured to communicate with the server.

71. The system of claim 70, wherein the database of the server stores a user profile associated with the user of the motion tracking device.

72. The system of claim 71, wherein the server is configured to update the user profile stored in the database responsive to the determination that the user of the motion tracking device performed the activity.

73. The system of claim 72, wherein the updating the user profile includes associating an award with the user profile.

74. The system of claim 65, further comprising:
a second motion tracking device including:
a second real-time clock configured to generate time data;
a second energy storage device configured to store electrical power operable to power the real-time clock;
a second energy harvester configured to charge the energy storage device;
a second memory storing machine readable instructions;
a second control system including one or more processors configured to execute the machine-readable instructions to associate the time data with motion data that is indicative of a relative orientation of the device, movement of the device, or both; and
a second transceiver configured to transmit at least a portion of the motion data and the associated time data to the user device.

75. The system of claim 62, where in the energy storage device is a capacitor.

76. A device comprising:
a temperature sensor configured to generate temperature data associated with a user;
an energy storage device configured to store electrical power operable to power the temperature sensor;
an energy harvester configured to charge the energy storage device;
a memory storing machine readable instructions;
a control system including one or more processors configured to execute the machine-readable instructions to determine a temperature of the user based at least in part on the temperature data.

77. The device of claim 76, further comprising a transceiver configured to transmit information indicative of the determined body temperature of the user to a user device, wherein the transceiver includes a radio-frequency identification (RFID) chip, a near-field communication (NFC) chip, a Bluetooth Low Energy (BLE) chip, or any combination thereof.

78-79. (canceled)

80. The device of claim 76, further comprising a display configured to display information associated with the determined body temperature of the user, wherein the display includes an electrophoretic display, a memory-in-pixel display, or both.

81-85. (canceled)

86. The device of claim 76, wherein the energy harvester includes an actuator configured to generate an electromotive force (EMF) responsive to movement of the device and, wherein the actuator includes a housing, a coil surrounding a portion of the cylinder, and a magnet that is disposed within the housing and is moveable relative to coil responsive to movement of the device.

87. (canceled)

88. The device of claim 86, wherein the actuator includes:
a housing;
a first magnet disposed within the housing and coupled to a first end of the housing via a first spring;
a first coil surrounding a first portion of the housing adjacent to the first magnet;
a second magnet disposed within the housing and coupled to a first end of the housing via a second spring;
a second coil surrounding a second portion of the housing adjacent to the second magnet; and
a non-magnetic mass disposed within the housing between the first magnet and the second magnet such that the non-magnetic mass moves relative to the housing responsive to movement of the device, wherein movement of the non-magnetic mass towards (i) the first end of the housing causes the first magnet to move relative to the first coil and (ii) the second end of the housing to move relative to the second coil.

89-93. (canceled)

94. A method comprising:
prompting a user to move a measurement device to cause an energy harvester to generate energy for powering a temperature sensor of the measurement device;
prompting a user to move the measurement device to cause the temperature sensor to generate temperature data associated with a body temperature of the user;
automatically transmitting at least a portion of the temperature data from the measurement device to a user device; and
causing the user device to display one or more indications indicative of the body temperature of the user based at least in part on the temperature data.

95-106. (canceled)
